(19) United States
(12) Patent Application Publication
(10) Pub. No.: US 2002/0092393 A1
(43) Pub. Date: Jul. 18, 2002

(54) Traversing circular saw

(76) Inventor: Doug Mains, (US)

Correspondence Address: TED WHITLOCH, REGISTERED PATENT ATTORNEY, P.A., 5323 SW 38TH AVE., FT.LAUDERDALE, FL, 33312, US

(21) Appl. No.: 09/873,104

(22) Filed: Jun. 1, 2001

Related U.S. Application Data
(60) Provisional application No. 60/208,512, filed on Jun. 1, 2000.
(60) Provisional application No. 60/277,406, filed on Mar. 19, 2001.

(51) Int. Cl. B26D 7/00; B26D 1/18; B23D 19/00

(52) U.S. Cl. 83/167; 83/485; 83/489

(57) ABSTRACT

A traversing circular saw device having a saw blade assembly mounted onto a cradle which can receive a number of logs to be cut into sections. The saw blade assembly includes a circular saw blade mounted onto an extension arm which is contained within an arm sleeve. The width of the cradle is greater than the diameter of the saw blade. The saw blade is extended across the cradle by a piston. One embodiment of the invention includes a charge accumulator for the hydraulic system which can time-delay engagement of the extension means. The system can also include a flow control valve for varying the time delay of the charge accumulator.

### BACKGROUND OF THE INVENTION

This invention relates generally to the field of circular saws, and more particularly to the field of circular saws which move relative to the work piece being cut. Even more particularly, the invention relates to large circular saws moved hydraulically in a traversing motion relative to an optional workplace receiving cradle, such as saws used in the logging industry to cut trees into short wood lengths.

There are numerous steps in bringing a tree from the forest to a mill for final processing into lumber, pulp, etc. Each tree is felled, delimbed and transported by truck to the mill. For some uses the logs are cut into short sections, usually from 4 to 8 feet in length. Cutting short wood, as it is known, may occur in the field prior to loading on the trucks, at intermediary wood yards for loading the wood onto trucks or rail cars, or at the mill itself. For increased speed, a number of logs (typically 2-20) are cut in a single pass with a large saw, rather than being cut individually. A motorized piece of heavy equipment known as a loader picks up several logs with a large grapple—a pincer type device— and loads them into the cradle or bunk of the saw. When the cradle is filled to the maximum allowable height, a hydraulically operated butt board evens the ends, the logs are cut by the saw and the short wood is removed by the grapple and placed on the truck or into train cars. The loader then uses the grapple to grasp and slide the remaining log lengths forward past the saw and the process is repeated.

There are three standard saws in use for this type of operation. The first type consists of an elongated chain saw typically 4 to 5 feet in length which pivots from a recessed vertical position just to one side of the cradle down to a horizontal position during the cutting stroke. The recessed position allows the logs to be moved in the cradle and protects the saw blade from damage. The other two types use circular saw blades of up to 5 feet in diameter. In one type, the blade is pivoted from a recessed vertical position down into the cradle, in a manner similar to the chain saw type. In the other type, the blade is mounted on a multi-jointed elbow-like arm which brings the blade from the recessed position across the cradle. The circular saws are more powerful than the chain saw type, and the chain saw type cannot be used in northern locations on frozen trees. Additionally, the chain saw types are easily bound or stalled by the logs and breakage of the chain is common.

The circular saws, powered hydraulically, can be used under substantially all conditions. A primary drawback of the first type of circular saw described, which only pivots down onto the logs to be cut, is that the width of the cradle is limited by the size of the blade diameter. Since the blade must extend slightly beyond all the logs to make full cuts, the cradle must have a width smaller than the diameter of the blade and the depth of the cradle must be kept well below the center of the blade. Because the cradle size is limited, the amount of wood able to be cut with each pass is also limited. To utilize a wider cradle, and thereby increase the amount of wood able to be cut in a single pass, the second type of saw is used. This type of circular uses a jointed mechanism to hydraulically extend the saw blade across the cradle. The multi-jointed arm moves the blade across the cradle with an elbow-like action. Because of this mechanism, the saw blade is readily subject to binding and stoppage, since the multi-jointed arm is not strong enough to counter any shifting of logs against the blade. This forces the blade off-line and results in stoppage, requiring the operator to retract the blade and start over.

Yet another variation of the circular saw embodiments is described in U.S. Pat. No. 5,408,907 which describes a traversing circular saw device having a saw blade assembly comprises a circular saw blade mounted onto an extension arm which is contained within a pivoting arm sleeve. The saw blade is pivoted down into the cradle by a first piston, and the blade is then extended across the cradle by a second piston. However, the extra pivoting step required by this device can increase the time involved for cutting the logs. In addition, this device is more complex and requires additional parts and engineering for accomplishing the pivoting step.

Thus, what is needed is a circular saw which addresses and obviates these disadvantages present in the currently available saws.

### SUMMARY OF THE INVENTION

The invention comprises a circular saw blade mounted onto or in relation to a cradle which can receive a quantity of delimbed logs, the cradle providing a means to retain the logs while the saw blade cuts the log lengths into sections. The cradle comprises a plurality of generally vertical members mounted to generally horizontal base cross members to provide a plurality of generally U-shaped retaining members. The U-shaped retaining members are preferably spaced longitudinally to retain the logs in the cradle during operation. The saw blade is movable relative to the cradle, having a fully retracted position to allow for log loading and a cutting movement comprising a lateral linear extension across or transverse to the cradle for cutting the logs.

The cradle has a longitudinal dimension to receive the logs and the saw blade is mounted such that the cutting path is perpendicular to that longitudinal dimension. The axis of rotation of the circular blade is parallel to the longitudinal axis of the cradle. The cradle extends longitudinally a certain length on one or both sides of the blade, such that the cradle retains both the uncut and cut sections of the each log. A butt board can be mounted on the cradle at one end to align the ends of the logs. The butt board can be operated hydraulically and is preferably adjustable such that short wood of different lengths can be cut.

The saw blade is connected to an extension arm which can be hydraulically extended from, and retracted into, an arm sleeve using an arm piston. With the blade in the retracted position, the cradle can be loaded with logs, and the butt board raised to even the ends of the logs. The saw blade, preferably powered by hydraulics, can then be extended from its retracted position via the arm piston, thus extending the saw blade transversely across the cradle in a linear manner, cutting the logs disposed in the cradle. The arm piston can then be retracted to return the extension arm back into the arm sleeve. The cut short wood can then be removed by the grappler, the remaining log lengths are shifted down and aligned using the butt board and the process repeated.

In one embodiment of the subject invention, the cradle and saw are mounted onto a wheeled trailer to allow the entire apparatus to be transported to any desired location. Also preferably, a protective housing can be positioned above the saw blade to guard the components from accidental damage when the blade is in the fully retracted position. It is also preferable that all operations of the invention, including the operation of the butt board, the pistons and the blade itself, be accomplished hydraulically.

In another embodiment, the hydraulic mechanism used for rotating the saw blade and the hydraulic system for extending the blade extension arm are a single system which comprises an in-line charge accumulator employing a time-delay valve. The charge accumulator provides for increased initial pressure in the hydraulic system and thereby increases the initial revolutions per minute (rpms) of the saw blade. The time-delay valve preferably includes an adjustment means for varying the time between switching on of the system and its engagement to rotate the saw blade and extend the extension arm.

It is an object of this invention to provide a circular saw which can be moved transversely across the cradle, such that the cradle width can be maximized. It is a further object to provide such a saw in which the blade is moved in a non-jointed and controlled manner, whereby shifting logs will not bind and stop the blade's rotation.

It is a further object to provide such a saw where the blade is moved hydraulically by at least one piston to reciprocate the blade across the cradle and back in a strictly linear motion.

It is yet another object of the invention to provide a circular saw which advantageously has increased initial rotational speed, or rpms, at the time of engagement so that the rpms are maximized as the saw blade is extended across the cradle to cut the logs.

### BRIEF DESCRIPTION OF THE DRAWINGS

FIG. 1 is an end view of the subject invention showing the saw blade and loaded cradle, with the blade in the retracted position.

FIG. 2 is a side view of the subject invention.

FIG. 3 is an end view of the subject invention showing the saw blade and empty cradle, with the blade in the extended, cutting position.

FIG. 4 is a schematic view of one embodiment of the system according to the subject invention, said system comprising a charge accumulator and a time delay valve in-line with the hydraulic drive means.

### DETAILED DESCRIPTION OF THE INVENTION

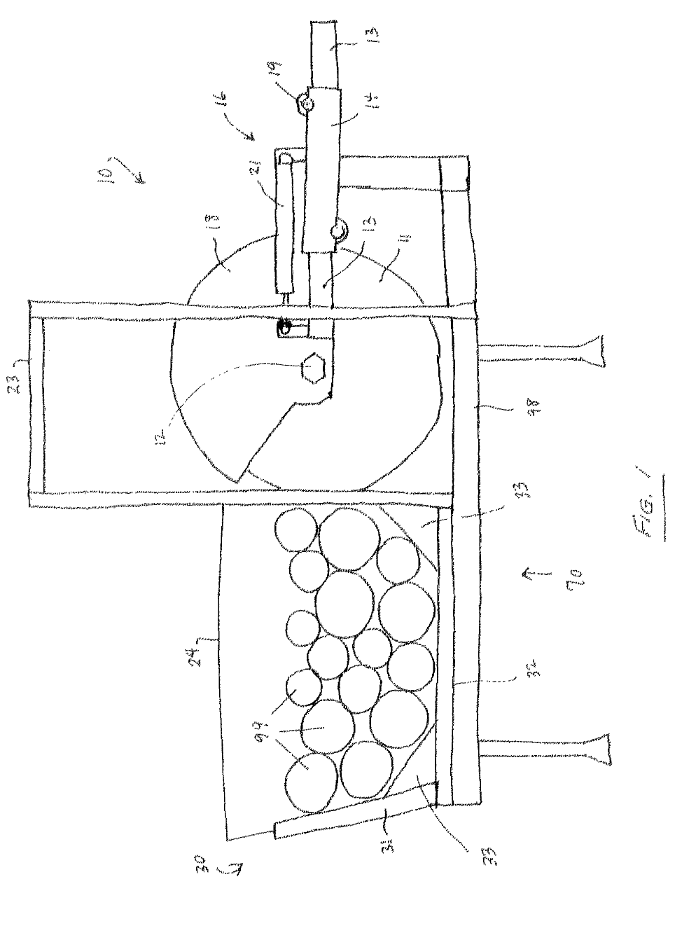

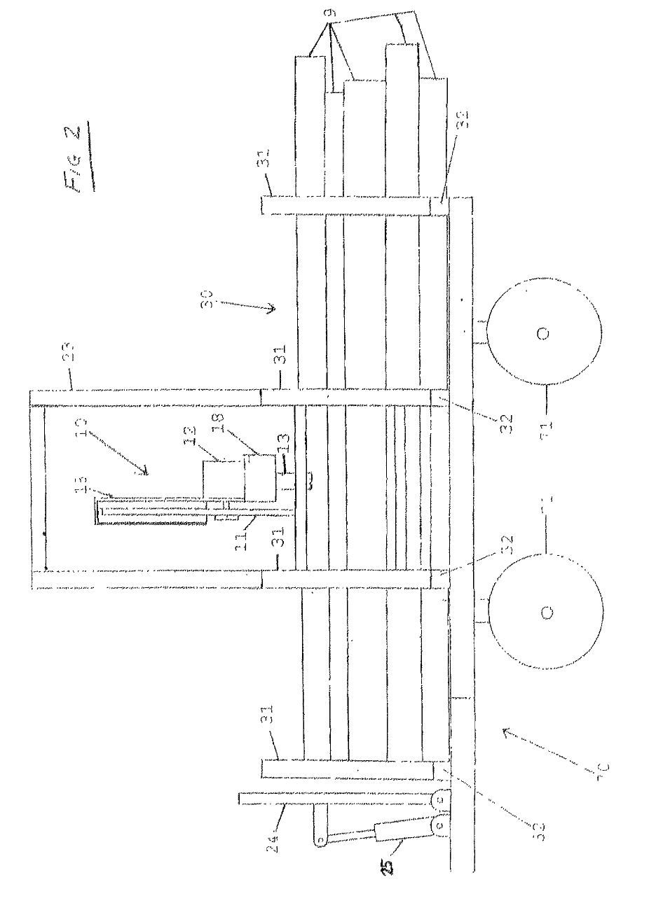

With reference to the Figures, the invention will now be described in detail, providing the preferred embodiment and best mode. As shown in FIGS. 1 and 2, the invention is an apparatus for cutting logs 99 into shorter segments for ease in handling, packing and transportation, comprising in general a circular saw blade assembly 10 mounted onto or connected to cradle means 30 for receiving the logs 99. Preferably, the apparatus is mounted on or incorporates a trailer 70, optionally having wheels (shown in FIG. 2) to facilitate moving the entire unit to any desired location.

Cradle means 30 is a receiving and holding means to retain the logs 99 in position during the cutting operation. Cradle means 30 also retains the cut segments of the logs 99 so that they can be removed by a grapple. Cradle means 30 extends longitudinally, such that the logs 99 are loaded lengthwise parallel to the longitudinal axis of the cradle means 30. Cradle means 30 can be constructed in various designs, provided a generally U-shaped channel in cross-section is formed. Preferably, cradle means 30 comprises a number of generally vertically oriented side members 31 mounted laterally in pairs along the length of the cradle means 30, with horizontal bottom members 32 connecting each opposing side members 31. Alternatively, bottom members 32 may be solid or apertured plates. The side members 31 are spaced a sufficient distance longitudinally to allow access to the logs 99 by a grapple for removal and placement. Corner plates 33 are inserted in each lower corner formed by the junction of a side member 31 and bottom member 32 to create the proper profile to position the logs 99 so that the circular saw blade 11 will extend slightly beyond each log 99 during the cutting operation. Preferably, cradle means 30 is formed of high strength steel members.

Saw blade assembly 10 comprises in general a circular saw blade 11, drive means 12 to rotate saw blade 11, an extension arm 13, an arm sleeve 14, and extending means (not shown) to move the extension arm 13. Saw blade assembly 10 is mounted onto or connected to cradle means 30 such that saw blade assembly 10 is relatively centrally located longitudinally, as seen in FIG. 2. Laterally, saw blade assembly 10 is mounted onto or connected to cradle means 30 to one side, as seen in FIG. 1, such that the assembly 10 does not intrude into cradle means 30 when the assembly 10 is in the retracted position.

The central rotational axis of saw blade 11 is parallel to the longitudinal axis of cradle means 30, such that the cutting path of saw blade 11 is transverse or across cradle means 30 laterally, perpendicular to the longitudinal axis. Saw blade 11 is a circular saw blade, preferably with removable cutting teeth. These blades are well known in the industry. Preferably, a large diameter blade, such as one with a diameter of five feet, is utilized.

The blade 11 is rotated by a drive means which can consist of any type of motor, including gasoline or electric, but is preferably a hydraulic motor powered by the hydraulic system of the loader itself and must provide sufficient rpm's to cut the logs 99, typically from 1200 to 1300 rpm's. Preferably, a housing shield 18 surrounds the non-cutting area of saw blade 11. Saw blade 11 is mounted onto one end of extension arm 13. Extension arm 13 is preferably constructed of a straight steel beam, and slidingly fits within arm sleeve 14 such that extension arm 13 moves longitudinally relative to arm sleeve 14, the internal cross-section of arm sleeve 14 corresponding generally to the external cross-section of extension arm 13. Roller members 19 positioned between extension arm 13 and arm sleeve 14 reduce friction and provide a rotating bearing surface to allow extension arm 13 to be easily moved relative to arm sleeve 14 by extending means 16. Extension arm 13 is much longer than arm sleeve 14, and arm sleeve 14 has both ends open so that extension arm 13 can protrude from either end. Extending means 16 preferably comprises an arm piston 21 mounted parallel to the main axis of extension arm 13 and arm sleeve 14. One end of arm piston 21 is attached to the extension arm 13 and the other end of arm piston 21 is attached to the arm sleeve 14. Arm piston 21 is preferably hydraulically operated, again by connections to the hydraulic system of the loader, and reciprocally extends and retracts the extension arm 13 in a linear manner out from and back into arm sleeve 14, thus extending and retracting saw blade 11 across cradle means 30.

As shown in FIG. 2, moveable abutment means 24, often referred to as a butt board in the industry, is connected to the framing 98 at the cutting end of the cradle means 30. Abutment means 24 acts to align the ends of the logs 99 after they have been placed into the cradle 30 and after they have been shifted to make the next cut. Typically, abutment means 24 is a large plate raised and lowered hydraulically by one or more butt board pistons 25.

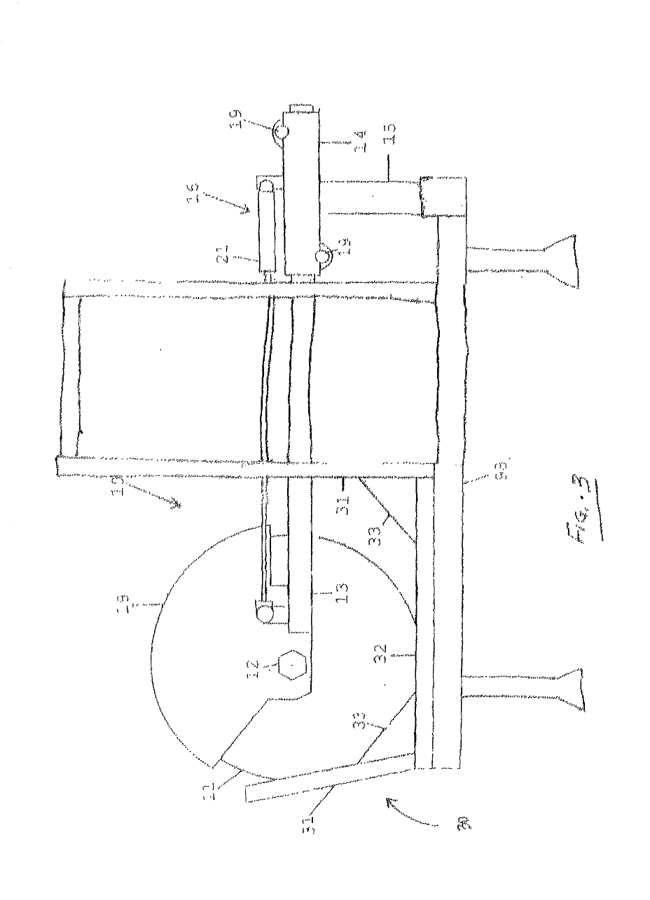

The operation of the invention is best illustrated by the series of FIG. 3, which shows the saw blade assembly 10 and the cradle means 30, but excludes the other components of the invention. In FIG. 3, as in FIG. 1, the saw blade assembly 10 is shown in the retracted position. The complete saw blade assembly 10 is to the side of the cradle means 30, allowing the logs 99 to be placed into position. Arm piston 21 is fully retracted, so that the extension arm 13 is fully retracted into arm sleeve 14, the free end of extension arm 13 extending from the far open end of sleeve arm 14.

In use, the saw blade 11 is kept rotating continuously. Once the logs 99 are properly positioned within the cradle means 30 and evened by the abutment means 24, the operator initiates extension of the extension arm 13 and arm sleeve 14. As the extension arm 31 is extended from arm sleeve 14 the saw blade 11 moves linearly across the cradle means 30 and rotating saw blade 11 enters the area defined by the cradle means 30, whereby the logs 99 occupying the cradle means 30 are cut during the traversing movement of the saw blade 11. Upon reaching the full extension, the saw blade 11 is retracted by retracting arm piston 21 and the saw blade assembly 10 is returned to its retracted position into the extension sleeve 14.

The cut segments of the logs 99 can now be removed by the loader, the remaining logs 99 pulled forward and the entire cycle repeated. Advantageously, the invention enables the lateral width of cradle means 30 to exceed the diameter of saw blade 11, thereby increasing the cutting area by up to several feet. The traversing action of the saw blade 11 as accomplished by the extending means 16 enables a much larger number of logs 99 to be cut by a single cutting cycle. Because the saw blade assembly 10 is fully retracted during loading, the near side of the cradle means 30 is fully accessible, and because the saw blade 11 is extended across the cradle means 30, more logs 99 can be loaded. For example, the cutting area of the invention is approximately 50 percent greater than the cutting area of the circular or chain saw type which only pivots. The cutting action of the invention is much more powerful than the type utilizing the multi-jointed elbow, since the cutting movement of the invention is solely linear and transverse to the length of the logs.

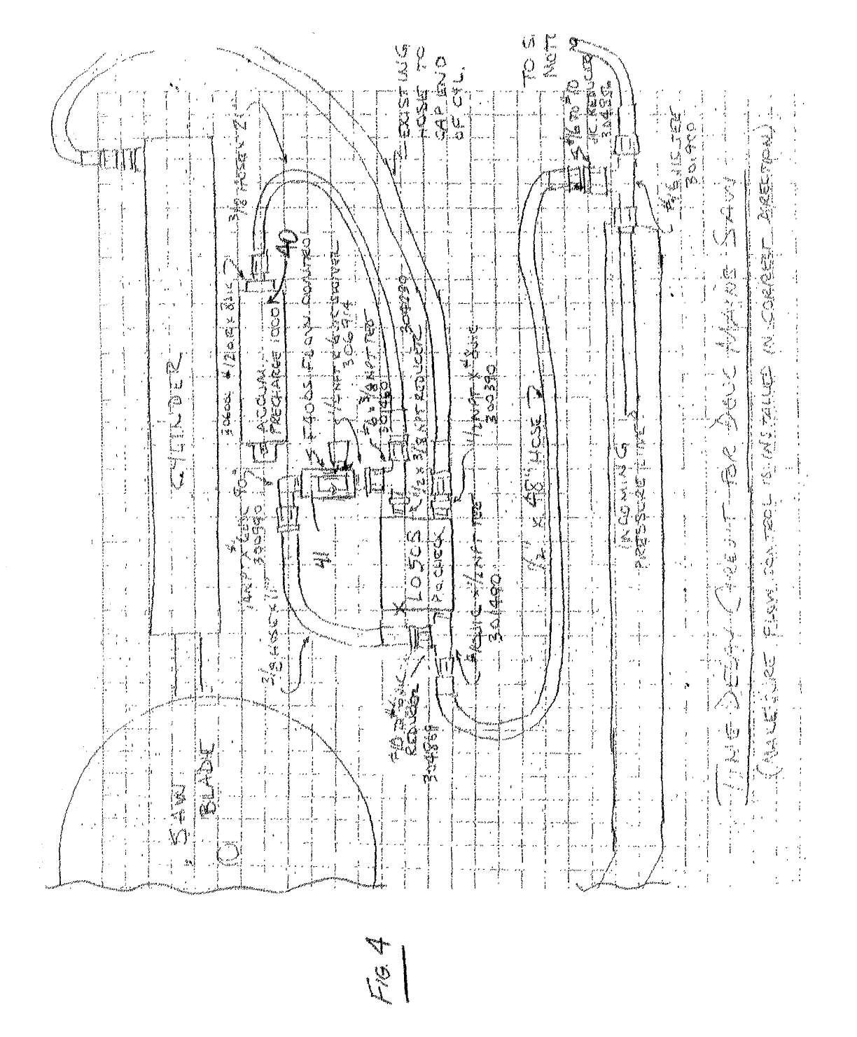

As shown in FIG. 4, the device is configured with a hydraulic driving means as is common in the art except that the device preferably includes a charge accumulator 40 connected in-line with the hydraulic system which drives the blade extension means (extension arm) and saw motor to rotate the saw blade. The charge accumulator can be time-delayed by means of a hydraulic flow control 41 which can vary or delay the time at which the pressure of the hydraulic fluid builds to reach a threshold such that the extension arm engages and thereby extends. The threshold pressure of the hydraulic fluid allows the extension arm to extend across the cradle means only after a certain rpm of the saw blade rotation is reached. A disadvantage of previously designed saws was that when the saw motor was initially operated by turning “on” the hydraulic system, the initial rotation of the saw blade was substantially less than optimum for cutting of the logs. Without a time-delay means (here, the charge accumulator), the extension arm was simultaneously engaged and extended across the logs when the rotation of the saw blade was less than the optimum rpm for efficient cutting. The subject invention can advantageously provide a traversing circular saw which is optimally engaged by a single on/off switching means. The term “optimally engaged” means that the saw blade is allowed to begin its rotation and reach a minimum rpm before the extension arm engages and extends across and cut the logs. The minimum rpm is set at a standard rpm for efficient cutting of the logs.

It is understood that equivalents and substitutions to elements in the above description may be apparent to those skilled in the art. The true scope and definition of the invention therefore is to be as set forth in the following claims.

What is claimed is:

1. A circular saw device for cutting a plurality of logs disposed in a cradle means, wherein said saw device comprises: a circular saw blade assembly comprising a circular saw blade, drive means to rotate said saw blade, an extension arm slidingly contained within an arm sleeve, extending means to extend said extension arm wherein said extending means is non-pivotally secured to said extension arm and said arm sleeve, wherein said saw blade is mounted in generally parallel alignment with the direction said extension arm is extended, wherein said extending means, during operation of said device, is for extending said extension arm and said saw blade across the cradle means in a direction generally perpendicular to the longitudinal axes of said logs to cut said logs into segments.

2. The device of claim 1, where said circular saw blade assembly is mounted onto the cradle means which has a width greater than the diameter of said circular saw blade.

3. The device of claim 1, further comprising abutment means to contact and thereby align said plurality of logs.

4. The device of claim 3, where said abutment means is adjustable in distance relative to said saw blase assembly.

5. The device of claim 1, where the cradle means is U-shaped in cross-section.

6. The device of claim 1, further comprising a tower connected to said cradle means and surrounding said saw blade assembly.

7. The device of claim 1, where said extending means comprises at least one hydraulic piston.

8. The device of claim 1, further comprising wheels attached to the cradle means.

9. The device of claim 1 wherein the device comprises a hydraulic system for operating the drive means and extension means, said hydraulic system including a charge accumulator for delaying the time of engagement of the saw blade motor and the extension arm.

10. The device of claim 9 wherein the device further comprises a time-delay valve for varying threshold hydraulic pressure in the charge accumulator.
